(19) United States
(12) Patent Application Publication
(10) Pub. No.: US 2023/0162007 A1
(43) Pub. Date: May 25, 2023

(54) METHOD AND APPARATUS FOR CONVOLUTION OPERATION OF CONVOLUTIONAL NEURAL NETWORK

(71) Applicant: INSTITUTE OF MICROELECTRONICS OF THE CHINESE ACADEMY OF SCIENCES, BEIJING (CN)

(72) Inventors: Feng ZHANG, BEIJING (CN); Qiang HUO, BEIJING (CN)

(73) Assignee: INSTITUTE OF MICROELECTRONICS OF THE CHINESE ACADEMY OF SCIENCES, BEIJING (CN)

(21) Appl. No.: 17/753,140

(22) PCT Filed: Feb. 22, 2021
(86) PCT No.: PCT/CN2021/077283

§ 371 Date: Feb. 21, 2022

(30) Foreign Application Priority Data
Jan. 8, 2021 (CN) 202110025418.8

(51) Int. Cl. G06N 3/0464; G06N 3/065

(52) U.S. Cl. CPC G06N 3/0464; G06N 3/065

(57) ABSTRACT

The present disclosure discloses a method and apparatus for convolution operation of a convolutional neural network. The method comprises acquiring input voltages used for characterizing pixel values; when the input voltages are scanned through convolutional sliding windows, obtaining times of reusing of the input voltages in the convolutional sliding windows; grouping the input voltages based on a difference in the times of reusing of the input voltages; extracting the input voltages in same groups once and performing convolution calculation with convolution kernels respectively, to obtain a result corresponding to each group; obtaining a result of convolution operation based on the result corresponding to each group, to implement convolution operation in the convolutional neural network. The present disclosure reduces energy consumption during convolution operations effectively.

### CROSS-REFERENCES TO RELATED APPLICATIONS

The application claims priority of a Chinese patent application No. 202110025418.8 filed on 8 Jan. 2021 and entitled “Method and apparatus for convolution operation of a convolutional neural network”, the entire contents of which are incorporated herein by reference.

### TECHNICAL FIELD

The present disclosure relates to a technical field of artificial intelligence algorithms, and in particular, to a method and apparatus for convolution operation of a convolutional neural network.

### BACKGROUND OF THE INVENTION

In the process of performing image processing by using a Convolutional Neural Network (CNN), a large number of convolutional calculations are required. Wherein when the convolutional calculation is performed on a data in a macro window, a same data needs to be extracted multiple times for convolution calculations, and every time the same data is extracted, the data needs to be read from the memory. Moreover, after the data is read each time, the process, of convolution calculation being performed through digital-to-analog converters, also increases a power consumption of the digital-to-analog converters.

Therefore, how to reduce the energy consumption in the process of convolution operation is an urgent technical problem to be solved at present.

### SUMMARY OF THE INVENTION

The object of the present disclosure is at least in part, to provide a method and apparatus for convolution operation of a convolutional neural network.

According to a first aspect of the present disclosure, there is provided a method for convolution operation of a convolutional neural network, comprising: acquiring input voltages used for characterizing pixel values; when the input voltages are scanned through convolutional sliding windows, obtaining times of reusing of the input voltages in the convolutional sliding windows; grouping the input voltages based on a difference in the times of reusing of the input voltages; extracting the input voltages in same groups once and performing convolution calculation with convolution kernels respectively, to obtain a result corresponding to each group; and obtaining a result of convolution operation based on the result corresponding to each group, to implement convolution operation in the convolutional neural network.

In some embodiments, the when the input voltages are scanned through convolutional sliding windows, obtaining times of reusing of the input voltages in the convolutional sliding window includes: when the input voltages are scanned through the convolutional sliding windows, obtaining a number of times that the input voltages appear in the convolutional sliding windows in a process of the convolutional sliding windows scanning from a first position, a second position, to a Q-th position according to a preset step length, and that is the times of reusing, and Q is a positive integer.

In some embodiments, the input voltages are input voltages of m channels, and the convolution kernels include m×n convolutional sliding windows, and both n and m are positive integers; where when a size of the input voltages is p×p, a size of the convolutional sliding windows is w×w, then 2≤w<p, and both p and w are positive integers.

In some embodiments, the extracting the input voltages in same groups once and performing convolution calculation with convolution kernels respectively, to obtain a result corresponding to each group includes: extracting the input voltages in the same groups once and performing multiply-accumulate operation with the convolution kernels respectively, to obtain a result corresponding to each group when the input voltages reused once in each group; and accumulating the result corresponding to each group when the input voltages reused once in each group according to the times of reusing, to obtain the result corresponding to each group.

In some embodiments, the obtaining a result of convolution operation based on the result corresponding to each group, to implement convolution operation in the convolutional neural network includes: adding the result corresponding to each group to obtain the result of convolution operation, to implement convolution operation in the convolutional neural network.

According to a second aspect of the present disclosure, there is provided an apparatus for convolution operation of a convolutional neural network comprising: an acquiring module configured to acquire input voltages used for characterizing pixel values; a first obtaining module configured to, when the input voltages are scanned through convolutional sliding windows, obtain times of reusing of the input voltages in the convolutional sliding windows; a grouping module configured to group the input voltages based on a difference in the times of reusing of the input voltages; a second obtaining module configured to extract the input voltages in same groups once and performing convolution calculation with convolution kernels respectively, to obtain a result corresponding to each group; a third obtaining module configured to obtain a result of convolution operation based on the result corresponding to each group, to implement convolution operation in the convolutional neural network.

In some embodiments, the first obtaining module is configured to, when the input voltages are scanned through the convolutional sliding windows, obtain a number of times that the input voltages appear in the convolutional sliding windows in a process of the convolutional sliding windows scanning from a first position, a second position, to a Q-th position according to a preset step length, and that is the times of reusing, and Q is a positive integer.

In some embodiments, the second obtaining module including: an extraction unit configured to extract the input voltages in the same groups once and perform multiply-accumulate operation with the convolution kernels respectively, to obtain a result corresponding to each group when the input voltages reused once in each group; and an accumulation unit configured to accumulate the result corresponding to each group when the input voltages reused once in each group according to the times of reusing, to obtain the result corresponding to each group.

According to a third aspect of the present disclosure, there is provided an electronic device comprising a memory, a processor and a computer program stored in the memory and capable of running on the processor, and the processor, when executing the computer program, implements steps of the methods described above.

According to a fourth aspect of the present disclosure, there is provided a computer-readable storage medium, in which a computer program is stored, when the computer program is executed by a processor, the steps of the methods described above are implemented.

One or more technical solutions provided in the present disclosure, by acquiring input voltages used for characterizing pixel values; when the input voltages are scanned through convolutional sliding windows, obtaining times of reusing of the input voltages in the convolutional sliding windows; grouping the input voltages based on a difference in the times of reusing of the input voltages; extracting the input voltages in same groups once and performing convolution calculation with convolution kernels respectively, to obtain a result corresponding to each group; obtaining a result of convolution operation based on the result corresponding to each group, to implement convolution operation in the convolutional neural network. Therefore, the input voltages reused for multiple times are read from the memory only once, which leads to reduce the consumption of digital-to-analog conversion during the convolution operation, and to effectively reduce the energy consumption during the convolution operation.

### BRIEF DESCRIPTION OF THE DRAWINGS

In order to more clearly illustrate the technical solutions in the embodiments of the present disclosure, a brief description of the accompanying drawings to be used in the description of the embodiments is given below. It is obvious that the accompanying drawings in the following description are merely to illustrate the embodiments of the present disclosure, and a person skilled in the art may also obtain other accompanying drawings based on the accompanying drawings provided in the present disclosure without any creative efforts.

FIG. 1 is a schematic diagram of a convolution operation of a convolutional neural network in the related art;

FIG. 2 is a schematic flowchart of a method for convolution operation of a convolutional neural network according to one or more embodiments of the present disclosure;

FIG. 3 is a schematic diagram of a structure of input data according to one or more embodiments of the present disclosure;

FIGS. 4a-4d are schematic diagrams of a process of a convolutional sliding window scanning input voltages according to one or more embodiments of the present disclosure;

FIG. 5 is a schematic diagram of a process of input voltages reused four times performing multiply-accumulate operation with m×n convolution kernels of 2×2 respectively according to one or more embodiments of the present disclosure;

FIGS. 6a-6d are schematic diagrams of a process of input voltages reused twice performing multiply-accumulate operation with m×n convolution kernels of 2×2 respectively according to one or more embodiments of the present disclosure.

FIGS. 7a-7d are schematic diagrams of a process of input voltages reused once performing multiply-accumulate operation with m×n convolution kernels of 2×2 respectively according to one or more embodiments of the present disclosure;

FIG. 8 is a schematic diagram of a structure of an apparatus for convolution operation of a convolutional neural network according to one or more embodiments of the present disclosure; and

FIG. 9 is a schematic diagram of a structure of an electronic device implementing a method for convolution operation of a convolutional neural network according to one or more embodiments of the present disclosure.

### DETAILED DESCRIPTION OF THE INVENTION

Exemplary embodiments of the present disclosure will be described in greater detail below with reference to the accompanying drawings. While the exemplary embodiments of the present disclosure are shown in the accompanying drawings, it should be understood, however, that the present disclosure can be implemented in various forms and should not be limited by the embodiments described herein. Rather, these embodiments are set forth here so as to provide a thorough understanding of the present disclosure and to convey the scope of the present disclosure completely to those skilled in the art.

It should be noted that similar reference signs and letters denote similar items in the following accompanying drawings, therefore, once an item is defined in one accompanying drawing, it is not necessary to be further defined or explained in the subsequent accompanying drawings. Also, in the description of this disclosure, the terms “first”, “second”, etc. are used merely to distinguish the description and are not to be construed as indicating or implying relative importance.

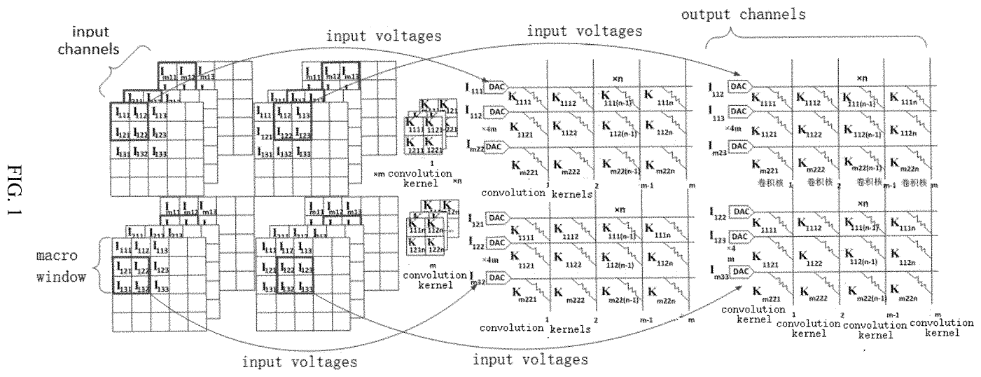

FIG. 1 shows a schematic diagram of an operation process of a convolution operation of a convolutional neural network in the related art. Wherein input data includes a plurality of input channels; a size of a macro window is 3×3; each data in the macro window is an input voltage used to characterize a pixel value. A convolutional sliding window with a size of 2×2 is used to scan the macro window, and convolutional kernels include m×n convolutional sliding windows of 2×2.

In the convolution operation in the related art, the input data needs to be subjected to convolution operation with the convolution kernels respectively, therefrom it can be seen that the input data I₁₂₂ located in a middle of the macro window in FIG. 1 needs to perform four convolution operations with the convolution kernels. Accordingly, the input data (I₁₁₂, I₁₂₃, I₁₂₁, I₁₃₂) located at the upper, lower, left, and right sides of the input data I₁₂₂ needs to perform two convolution operations with the convolution kernels respectively, and the input data (I₁₁₁, I₁₁₃, I₁₃₁, I₁₃₃) located at four corners of the macro window needs to perform one-time convolution operation with the convolution kernels respectively.

Therefore, the input data I₁₂₂ needs to be reused 4 times, and the input data I₁₁₂, I₁₂₃, I₁₂₁, I₁₃₂ need to be reused twice respectively. In this case, the input data I₁₂₂ needs to be read from a memory four times and the input data I₁₁₂, I₁₂₃, I₁₂₁, I₁₃₂ need to be read from the memory twice respectively. Therefore, the memory is occupied multiple times, which causes the problem of excessive energy consumption and low efficiency.

According to a first aspect of the present disclosure, there is provided a method for convolution operation of a convolutional neural network, which may effectively reduce the number of times the input data read from the memory, wherein the input data is reused for multiple times, and may effectively reduce energy consumption.

### EXAMPLE 1

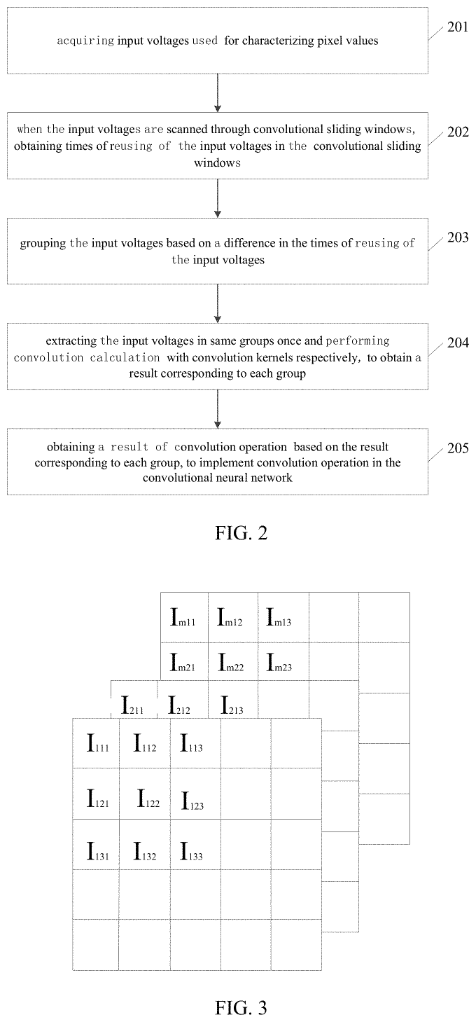

According to a first aspect of the present disclosure, there is provided a method of convolution operation of a convolutional neural network, as shown in FIG. 2, the method includes,

S201, acquiring input voltages used for characterizing pixel values;

S202, when the input voltages are scanned through convolutional sliding windows, obtaining times of reusing of the input voltages in the convolutional sliding windows;

S203, grouping the input voltages based on a difference in the times of reusing of the input voltages;

S204, extracting the input voltages in same groups once and performing convolution calculation with convolution kernels respectively, to obtain a result corresponding to each group; and

S205, obtaining a result of convolution operation based on the result corresponding to each group, to implement convolution operation in the convolutional neural network.

In some embodiments, the input voltages used to characterize the pixel values are specifically the input voltages from m channels, wherein m is a positive integer.

In accordance with the example shown in FIG. 3, there are m channels and as for input voltages from each channel, a 3×3 macro window is defined, and the 3×3 macro window located in a first layer contains the following nine input voltages, specifically, I₁₁₁, I₁₁₂, I₁₁₃, I₁₂₁, I₁₂₂, I₁₂₃, I₁₃₁, I₁₃₂, and I₁₃₃.

In the same way, the input voltages in the macro window of m layers are obtained.

Taking the macro window located in the first layer as an example, the input voltages are feature data extracted from an image, and the feature data is a data matrix of 3×3. Form channels, it is a data matrix of m×3×3.

After acquiring the input voltages of the m channels, step S202 is executed. When the input voltages are scanned through convolutional sliding windows, the times of reusing of the input voltages in the convolutional sliding windows is obtained.

In some embodiments, the input voltages are operated through the convolutional sliding window. Firstly, convolutional sliding windows are selected, taking a convolutional sliding window as an example.

The convolutional kernel is a feature weight of the convolutional neural network model. Each convolutional sliding window is a 2×2 weight matrix, i.e., the weight matrix has two rows, each row containing two weight elements, and each weight element is a weight value used for multiplying with the above-described input voltages.

The above-described input voltages and the convolution kernels may also be three-dimensional data. For m channels, the three-dimensional data is a data matrix of m×3×3. For m×n convolution kernels, the three-dimensional data is m×n weight matrices of 2×2.

Next, when the input voltages are scanned through a convolutional sliding window, specifically, a 3×3 data matrix is scanned through a 2×2 convolutional sliding window.

In some embodiments, during the scanning process, a number of times that the input voltages appear in the convolutional sliding windows is obtained in a process of the convolutional sliding windows scanning from a first position, a second position, to a Q-th position according to a preset step length, and that is the times of reusing, and Q is a positive integer.

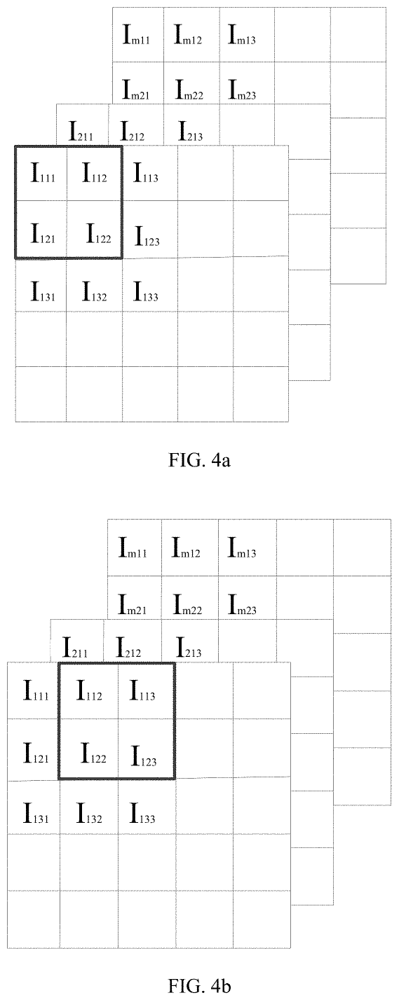

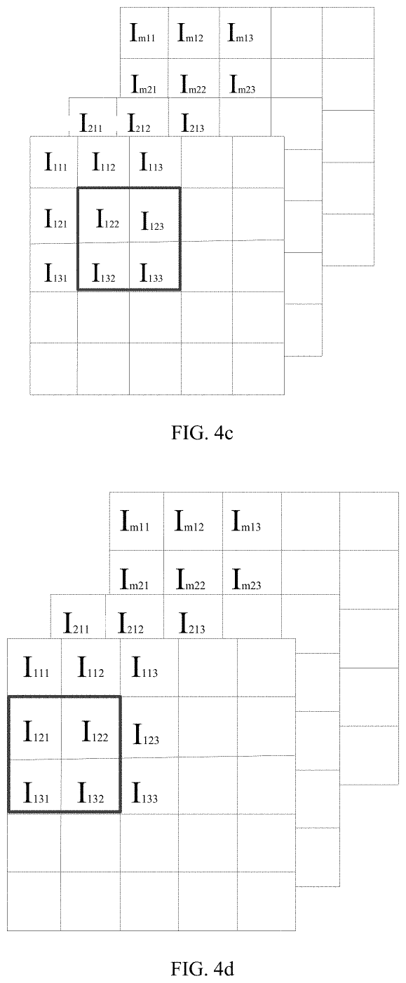

Specifically, as shown in FIG. 4a to FIG. 4d, the preset step length is 1. During the process of scanning the input voltages by using the convolutional sliding window, the first position is shown in FIG. 4a, the second position is shown in FIG. 4b, the third position is shown in FIG. 4c, and the fourth position is shown in FIG. 4d. The scanning of the input voltages is done completely through the above four positions.

During the scanning process, the number of times the input voltages appear in the convolutional sliding window is the times of reusing of the input voltages.

For example, taking nine input voltages, i.e., I₁₁₁, I₁₁₂, I₁₁₃, I₁₂₁, I₁₂₂, I₁₂₃, I₁₃₁, I₁₃₂, and I₁₃₃ which are contained in a 3×3 macro window located in the first layer, as an example, wherein, the number of times I₁₂₂ appears in the convolutional sliding window is four, i.e., the times of reusing of the input voltage I₁₂₂ is four. I₁₁₂, I₁₃₂, I₁₂₁, and I₁₂₃ appear twice in the convolutional sliding window respectively, i.e., the times of reusing of the input voltages I₁₁₂, I₁₃₂, I₁₂₁, and I₁₂₃ is two respectively. In addition, the number of times I₁₁₁, I₁₁₃, I₁₃₁, and I₁₃₃ appear in the convolutional sliding window is one respectively, i.e., the times of reusing of the input voltages I₁₁₁, I₁₁₃, I₁₃₁, and I₁₃₃ is 1 respectively.

After obtaining the times of reusing of each input voltage, Step S203 is executed that the input voltages are grouped based on a difference in the times of reusing of the input voltages.

Taking the above-described nine input voltages as an example, wherein the input voltage I₁₂₂ is in a first group, the input voltages I₁₁₂, I₁₃₂, I₁₂₁, I₁₂₃ are in a second group, and the input voltages I₁₁₁, I₁₁₃, I₁₃₁, I₁₃₃ are in a third group.

Next, S204 is executed. The input voltages in same groups are extracted once and are performed convolution calculation with convolution kernels respectively, to obtain a result corresponding to each group.

In some embodiments, the input voltages in the same groups are extracted once and are performed multiply-accumulate operation with the convolution kernels respectively, to obtain a result corresponding to each group when the input voltages reused once in each group.

Next, accumulating the result corresponding to each group when the input voltages reused once in each group according to the times of reusing, to obtain the result corresponding to each group.

For example, for the input voltage I₁₂₂, the times of reusing of the input voltage I₁₂₂ is four, and the input voltage I₁₂₂ can be performed convolution calculation with each 2×2 convolution kernel respectively. As shown in FIG. 5, for each channel in the m channels, there is a corresponding input voltage I_{X22}, wherein 1≤X<5, X represents different channels. After passing through a digital-to-analog converter (DAC), the input voltage I_{X22} is performed multiply-accumulate operation with m×n convolution kernels of 2×2 respectively, to obtain a result corresponding to the first group when the input voltage I_{X22} reused once in the first group.

Next, the result corresponding to the first group when the input voltages reused once in the first group is accumulated according to the times of reusing, i.e., the obtained result is accumulated four times according to the times of reusing, to obtain the result corresponding to the first group.

For the input voltage that is reused four times, it is read from the memory only once, thus avoiding reading the memory multiple times, and greatly improving the energy efficiency.

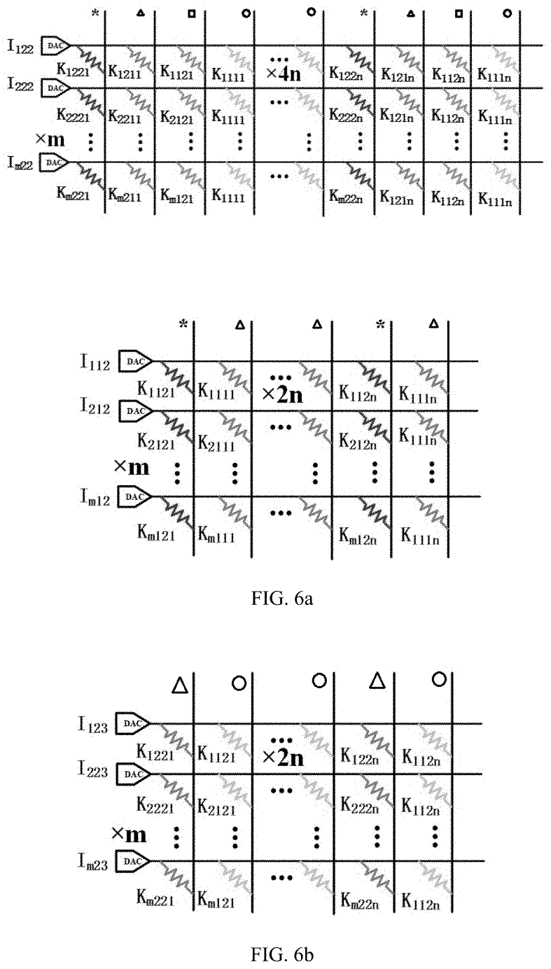

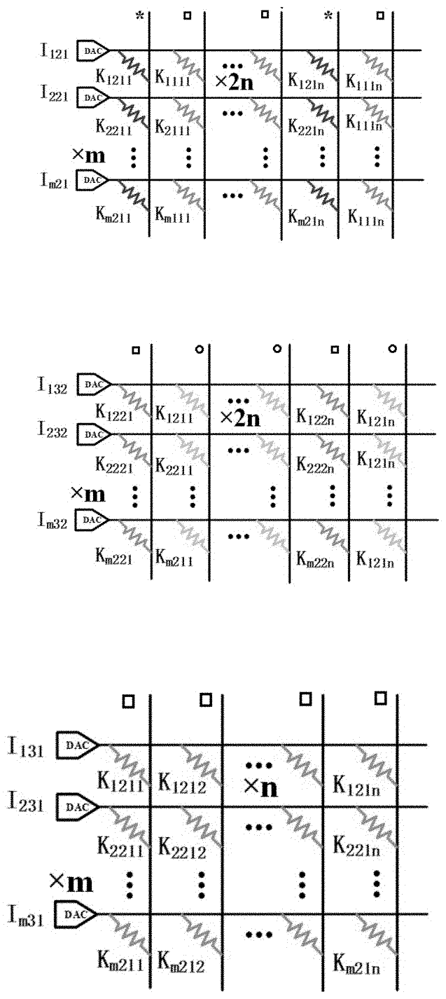

For the input voltages I₁₁₂, I₁₃₂, I₁₂₁, and I₁₂₃, the times of reusing of each input voltage of the second group is two. Each input voltage of the second group is performed convolution calculation with each 2×2 convolution kernel respectively. Specifically, as shown in FIGS. 6a to 6d, each of the m channels corresponds to 4 input voltages. After passing through the DAC, the input voltages of the second group are performed multiply-accumulate operation with m×n convolution kernels of 2×2 respectively. Thereby the result corresponding to the second group when the input voltages reused once in the second group is obtained.

Next, the result corresponding to the second group when the input voltages reused once in the second group is accumulated according to the times of reusing, i.e., the obtained result is accumulated twice according to the times of reusing, to obtain the result corresponding to the second group.

For the input voltages that are reused twice, they are read from the memory only once, thus avoiding reading the memory multiple times, and greatly improving the energy efficiency.

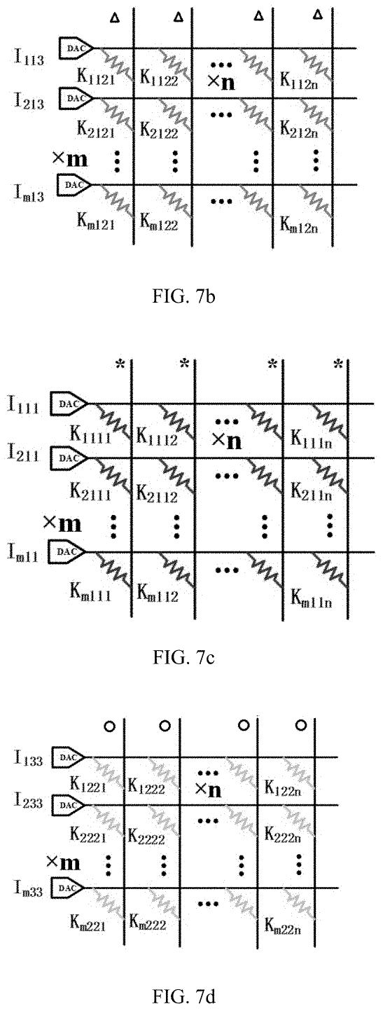

For input voltages I₁₁₁, I₁₁₃, I₁₃₁, and I₁₃₃, the time of reusing of each input voltages of the third group is one, Each input voltage of the third group may be performed convolution calculation with each 2×2 convolution kernel respectively. Specifically, as shown in FIGS. 7a to 7d, each of the m channels corresponds to 4 input voltages. After passing through the DAC, the input voltages of the third group are performed multiply-accumulate operation with m×n convolution kernels of 2×2 respectively. Thereby the result corresponding to the third group when the input voltages reused once in the third group is obtained.

Since the times of reusing of the input voltages in the third group is one, therefore, the result corresponding to the third group when the input voltages reused once in the third group is the result corresponding to the third group.

As shown in the above FIG. 5, FIG. 6a to FIG. 6d, and FIG. 7a to FIG. 7d, wherein, the column marked with the symbol “*” represents the convolution calculation corresponding to the convolutional sliding window when being at the first position, the column marked with symbol “Δ” represents the convolution calculation which corresponds to the convolutional sliding window when being at the second position. The column marked with symbol “∘” represents the convolution calculation corresponding to the convolutional sliding window located when being at the third position, and the column marked with symbol “□” represents the convolution calculation corresponding to the convolutional sliding window when being at the fourth position.

A size of input voltages being 3×3, and a size of the convolutional sliding windows being 2×2 has been mentioned above as an example.

In fact, if a size of the input voltages is p×p, and a size of corresponding convolutional sliding windows is w×w, then 2≤w<p, wherein both p and w are positive integers.

After the result corresponding to each group is obtained, S205 is executed to obtain a result of convolution operation based on the result corresponding to each group, to implement convolution operation in the convolutional neural network.

In some embodiments, the result corresponding to each group is added, to obtain a result of convolution operation, to implement convolution operation in the convolutional neural network.

In accordance with the above example, the result corresponding to the first group, the result corresponding to the second group and the result corresponding to the third group are added to obtain the result of convolution operation, thus implementing the convolution operation in the convolutional neural network.

Therefore, the number of components required in the related art shown in FIG. 1 is 4 mn×4=16 mn; and the number of components required for the convolution operation in the convolutional neural network provided in the present disclosure is mn+2 mn+2 mn+mn+mn+2 mn+2 mn+mn+4 mn=16 mn.

It can be seen therefrom that the number of components consumed in the present disclosure is the same as the number of components consumed in the related art. Therefore, the present disclosure does not increase the consumption of array areas.

One or more technical solutions provided in the present disclosure, by acquiring input voltages used for characterizing pixel values; when the input voltages are scanned through convolutional sliding windows, obtaining times of reusing of the input voltages in the convolutional sliding windows; grouping the input voltages based on a difference in the times of reusing of the input voltages; extracting the input voltages in same groups once and performing convolution calculation with convolution kernels respectively, to obtain a result corresponding to each group; obtaining a result of convolution operation based on the result corresponding to each group, to implement convolution operation in the convolutional neural network. Therefore, the input voltages reused for multiple times are read from the memory only once, which leads to reduce the consumption of digital-to-analog conversion during the convolution operation, and to effectively reduce the energy consumption during the convolution operation.

### EXAMPLE 2

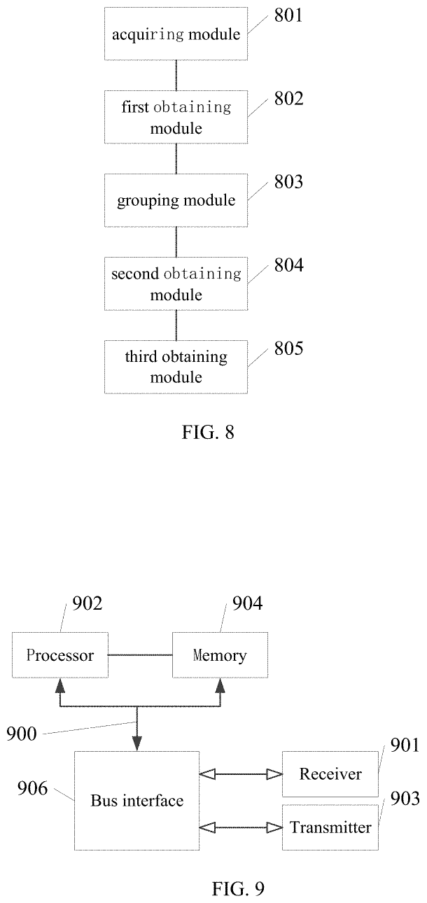

In a second aspect of the present disclosure, there is also provided an apparatus for convolution operation of a convolutional neural network, as shown in FIG. 8, and the apparatus includes:

an acquiring module 801 configured to acquire input voltages used for characterizing pixel values;

a first obtaining module 802 configured to, when the input voltages are scanned through convolutional sliding windows, obtain times of reusing of the input voltages in the convolutional sliding windows;

a grouping module 803 configured to group the input voltages based on a difference in the times of reusing of the input voltages;

a second obtaining module 804 configured to extract the input voltages in same groups once and performing convolution calculation with convolution kernels respectively, to obtain a result corresponding to each group;

a third obtaining module 805 configured to obtain a result of convolution operation based on the result corresponding to each group, to implement convolution operation in the convolutional neural network.

In some embodiments, the first obtaining module 802 is configured to, when the input voltages are scanned through the convolutional sliding windows, obtain a number of times that the input voltages appear in the convolutional sliding windows in a process of the convolutional sliding windows scanning from a first position, a second position, to a Q-th position according to a preset step length, and that is the times of reusing, and Q is a positive integer.

In some embodiments, the input voltages are input voltages of m channels, and the convolution kernels include m×n convolutional sliding windows; when size of the input voltages is p×p, a size of the convolutional sliding windows is w×w, then 2≤w<p, and both p and w are positive integers.

In some embodiments, the second obtaining module 804 includes, an extraction unit configured to extract the input voltages in the same groups once and perform multiply-accumulate operation with the convolution kernels respectively, to obtain a result corresponding to each group when the input voltages reused once in each group; an accumulation unit configured to accumulate the result corresponding to each group when the input voltages reused once in each group according to the times of reusing, to obtain the result corresponding to each group.

In some embodiments, the third obtaining module 805 is configured to add the result corresponding to each group to obtain the result of convolution operation, to implement convolution operation in the convolutional neural network.

### EMBODIMENT 3

In a third aspect of the present disclosure, an electronic device is provided, as shown in FIG. 9, the electronic device including a memory 904, a processor 902 and a computer program 904 stored in the memory 904 and capable of running on the processor 902, and the processor 902, when executing the computer program, implements steps of the method for convolution operation of a convolutional neural network described above.

In some embodiments, in FIG. 9, a bus architecture (represented by bus 900) is shown. The bus 900 may include any number of interconnected buses and bridges, and the bus 900 links together various circuits of one or more processors represented by processor 902 and a memory represented by memory 904. The bus 900 may also link together various other circuits, such as a peripheral device, a voltage regulator, and a power management circuit and the like, and these are well known in the art, and thus will not be further described herein. A bus interface 906 provides interfaces among the bus 900, a receiver 901 and a transmitter 903. The receiver 901 and the transmitter 903 may be a same element, i.e., a transceiver, providing a unit for communicating with various other devices via a transmission medium. The processor 902 is responsible for managing the bus 900 and general processing, and the memory 904 may be configured to store data used by the processor 902 when the processor 902 performs operations.

### EMBODIMENT 4

In a fourth aspect of the present disclosure, there is provided a computer-readable storage medium in which a computer program is stored. When the computer program is executed by a processor, the steps of the method for convolution operation of the convolutional neural network described above are implemented.

The algorithms and demonstrations provided herein are not inherently associated with any particular computer, virtual system, or other devices. Various general-purpose systems may also be used together with the teachings herein. According to the description above, a structure required to construct such a system is obvious. Furthermore, the present disclosure is not directed to any particular programming language. It should be understood that various programming languages may be utilized to implement the present disclosure described herein, and the description made with respect to the particular languages above is used to disclose the preferred embodiments of the present disclosure.

In the specification provided herein, a large number of specific details are described. However, it can be understood that embodiments of the present disclosure can be implemented without these specific details. In some examples, well-known methods, structures and techniques are not shown in detail so as not to obscure an understanding of the present disclosure.

Similarly, it should be understood that in order to streamline the present disclosure and aid in the understanding of one or more of the various aspects of the disclosure, various features of the present disclosure are sometimes grouped together in a single embodiment, figure, or description thereof in the above description of the exemplary embodiments of the present disclosure. However, the method of the disclosure should not be construed to reflect an intention that the present disclosure claimed to be protected requires more features than those expressly set forth in each claim. More precisely, as reflected in the claims below, the inventive aspects have fewer features than all features of a single embodiment disclosed above. Accordingly, the claim that follows a specific embodiment is hereby expressly incorporated into the specific embodiment, wherein each claim itself may be regarded as a separate embodiment of the present disclosure.

Those skilled in the art may understand that the modules in the apparatus in the embodiments can be adaptively changed and put in one or more devices different from the embodiments. The modules or units or components in the embodiments may be combined into a single module or unit or component, and in addition, they may be divided into a plurality of sub-modules or sub-units or sub-components. Except at least some of such features and/or processes or units which are mutually exclusive, any combination of all features disclosed in the specification (including the accompanying claims, the abstract, and the accompanying drawings) and all processes or units of any method or any apparatus disclosed in such way may be employed. Unless particularly clearly stated otherwise, each feature disclosed in the specification (including the accompanying claims, the abstract, and the accompanying drawings) may be replaced by alternative features that provide the same, equivalent, or similar purpose.

Further, those skilled in the art may understand that although some embodiments herein include certain features included in other embodiments rather than other features in the other embodiments, combinations of the features in different embodiments is meant to be within the scope of the present disclosure and forms different embodiments. For example, in the claims below, any one of the embodiments claimed to be protected may be used in any combination.

The embodiments of various components of the present disclosure may be implemented by hardware, or by software modules running on one or more processors, or in a combination thereof. It should be understood by those skilled in the art that, in practice, a microprocessor or a digital signal processor (DSP) may be used to implement some or all of the functions of some or all of the components of the apparatus for convolutional operation of a convolutional neural network and the electronic device according to the present disclosure. The present disclosure may also be implemented as an apparatus or device program (e.g., a computer program and a computer program product) for executing some or all of the methods described herein. Such programs implementing the present disclosure may be stored on a computer-readable medium or may be in the form of one or more signals. Such signals may be accessed by downloading from an Internet website, or provided on a carrier signal, or provided in any other form.

It should be noted that the above embodiments are to illustrate and not to limit the present disclosure, and alternative embodiments may be devised by those skilled in the art without departing from the scope of the appended claims. In the claims, any reference signs located between parentheses should not be construed as limitations to the claims. The words “comprising”, “including” or “containing” do not exclude the presence of an element or step not listed in the claim. The word “a” or “an” preceding an element/a component/a unit does not exclude the existence of plenty of such elements/components/units. The present disclosure may be implemented by means of hardware comprising a number of different elements or by means of a suitably programmed computer. In a group of claims enumerating several devices, several of these devices may be specifically embodied by the same hardware item. The words “first”, “second”, and “third” etc., used in the present disclosure do not indicate any order, but may be interpreted as names.

1. A method for convolution operation of a convolutional neural network comprising:
acquiring input voltages used for characterizing pixel values;
when the input voltages are scanned through convolutional sliding windows, obtaining times of reusing of the input voltages in the convolutional sliding windows;
grouping the input voltages based on a difference in the times of reusing of the input voltages;
extracting the input voltages in same groups once and performing convolution calculation with convolution kernels respectively, to obtain a result corresponding to each group; and
obtaining a result of convolution operation based on the result corresponding to each group, to implement convolution operation in the convolutional neural network.

2. The method of claim 1, wherein the when the input voltages are scanned through convolutional sliding windows, obtaining times of reusing of the input voltages in the convolutional sliding window includes:
when the input voltages are scanned through the convolutional sliding windows, obtaining a number of times that the input voltages appear in the convolutional sliding windows in a process of the convolutional sliding windows scanning from a first position, a second position, to a Q-th position according to a preset step length, and that is the times of reusing, and Q is a positive integer.

3. The method of claim 1, wherein the input voltages are input voltages of m channels, and the convolution kernels include m×n convolutional sliding windows, and both n and m are positive integers;
where when a size of the input voltages is p×p, a size of the convolutional sliding windows is w×w, then 2≤w<p, and both p and w are positive integers.

4. The method of claim 1, wherein the extracting the input voltages in same groups once and performing convolution calculation with convolution kernels respectively, to obtain a result corresponding to each group includes:
extracting the input voltages in the same groups once and performing multiply-accumulate operation with the convolution kernels respectively, to obtain a result corresponding to each group when the input voltages reused once in each group; and
accumulating the result corresponding to each group when the input voltages reused once in each group according to the times of reusing, to obtain the result corresponding to each group.

5. The method of claim 1, wherein the obtaining a result of convolution operation based on the result corresponding to each group, to implement convolution operation in the convolutional neural network includes:
adding the result corresponding to each group to obtain the result of convolution operation, to implement convolution operation in the convolutional neural network.

6. An apparatus for convolution operation of a convolutional neural network, comprising:
an acquiring module configured to acquire input voltages used for characterizing pixel values;
a first obtaining module configured to, when the input voltages are scanned through convolutional sliding windows, obtain times of reusing of the input voltages in the convolutional sliding windows;
a grouping module configured to group the input voltages based on a difference in the times of reusing of the input voltages;
a second obtaining module configured to extract the input voltages in same groups once and performing convolution calculation with convolution kernels respectively, to obtain a result corresponding to each group;
a third obtaining module configured to obtain a result of convolution operation based on the result corresponding to each group, to implement convolution operation in the convolutional neural network.

7. The apparatus of claim 6, wherein the first obtaining module is configured to,
when the input voltages are scanned through the convolutional sliding windows, obtain a number of times that the input voltages appear in the convolutional sliding windows in a process of the convolutional sliding windows scanning from a first position, a second position, to a Q-th position according to a preset step length, and that is the times of reusing, and Q is a positive integer.

8. The apparatus of claim 6, wherein the second obtaining module including:
an extraction unit configured to extract the input voltages in the same groups once and perform multiply-accumulate operation with the convolution kernels respectively, to obtain a result corresponding to each group when the input voltages reused once in each group; and
an accumulation unit configured to accumulate the result corresponding to each group when the input voltages reused once in each group according to the times of reusing, to obtain the result corresponding to each group.

9. An electronic device, comprising a memory, a processor and a computer program stored in the memory and capable of running on the processor, and the processor, when executing the computer program, implements steps of the method as claimed in claim 1.

10. A computer-readable storage medium, in which a computer program is stored, when the computer program is executed by a processor, steps of the method as claimed in claim 1.

11. The electronic device of claim 9, when executing the computer program, implements the following steps: the when the input voltages are scanned through convolutional sliding windows, obtaining times of reusing of the input voltages in the convolutional sliding window includes:
when the input voltages are scanned through the convolutional sliding windows, obtaining a number of times that the input voltages appear in the convolutional sliding windows in a process of the convolutional sliding windows scanning from a first position, a second position, to a Q-th position according to a preset step length, and that is the times of reusing, and Q is a positive integer.

12. The electronic device of claim 11, when executing the computer program, implements the following steps: the input voltages are input voltages of m channels, and the convolution kernels include m×n convolutional sliding windows, and both n and m are positive integers;
where when a size of the input voltages is p×p, a size of the convolutional sliding windows is w×w, then 2≤w<p, and both p and w are positive integers.

13. The electronic device of claim 12, when executing the computer program, implements the following steps: the extracting the input voltages in same groups once and performing convolution calculation with convolution kernels respectively, to obtain a result corresponding to each group includes:
extracting the input voltages in the same groups once and performing multiply-accumulate operation with the convolution kernels respectively, to obtain a result corresponding to each group when the input voltages reused once in each group; and
accumulating the result corresponding to each group when the input voltages reused once in each group according to the times of reusing, to obtain the result corresponding to each group.

14. The electronic device of claim 13, when executing the computer program, implements the following steps: the obtaining a result of convolution operation based on the result corresponding to each group, to implement convolution operation in the convolutional neural network includes:
adding the result corresponding to each group to obtain the result of convolution operation, to implement convolution operation in the convolutional neural network.

15. The computer-readable storage medium as claimed in claim 10, when the computer program is executed by the processor, the following steps are implemented: the when the input voltages are scanned through convolutional sliding windows, obtaining times of reusing of the input voltages in the convolutional sliding window includes:
when the input voltages are scanned through the convolutional sliding windows, obtaining a number of times that the input voltages appear in the convolutional sliding windows in a process of the convolutional sliding windows scanning from a first position, a second position, to a Q-th position according to a preset step length, and that is the times of reusing, and Q is a positive integer.

16. The computer-readable storage medium as claimed in claim 15, when the computer program is executed by the processor, the following steps are implemented: the input voltages are input voltages of m channels, and the convolution kernels include m×n convolutional sliding windows, and both n and m are positive integers;
where when a size of the input voltages is p×p, a size of the convolutional sliding windows is w×w, then 2≤w<p, and both p and w are positive integers.

17. The computer-readable storage medium as claimed in claim 16, when the computer program is executed by the processor, the following steps are implemented: the extracting the input voltages in same groups once and performing convolution calculation with convolution kernels respectively, to obtain a result corresponding to each group includes:
extracting the input voltages in the same groups once and performing multiply-accumulate operation with the convolution kernels respectively, to obtain a result corresponding to each group when the input voltages reused once in each group; and
accumulating the result corresponding to each group when the input voltages reused once in each group according to the times of reusing, to obtain the result corresponding to each group.

18. The computer-readable storage medium as claimed in claim 17, when the computer program is executed by the processor, the following steps are implemented: the obtaining a result of convolution operation based on the result corresponding to each group, to implement convolution operation in the convolutional neural network includes:
adding the result corresponding to each group to obtain the result of convolution operation, to implement convolution operation in the convolutional neural network.
